(19) United States
(12) Patent Application Publication
(10) Pub. No.: US 2016/0052371 A1
(43) Pub. Date: Feb. 25, 2016

(54) AIR CLEANER ASSEMBLY

(71) Applicant: CATERPILLAR INC., Peoria, IL (US)

(72) Inventors: Mark Taylor Allott, Mapleton, IL (US); Mark Alan Rosenfeld, Peoria, IL (US); Beverly Marie Rasmussen, Peoria Heights, IL (US); Philip Spengler, Washington, IL (US); Jacquelynn Rae Baum, Glasford, IL (US)

(73) Assignee: CATERPILLAR INC., PEORIA, IL (US)

(21) Appl. No.: 14/463,351

(22) Filed: Aug. 19, 2014

(51) Int. Cl. B60H 3/06; B01D 46/52; B01D 46/00

(52) U.S. Cl. CPC B60H 3/0608; B01D 46/0005; B01D 46/002; B01D 46/521

(57) ABSTRACT

Disclosed are various exemplary embodiments of an air cleaner assembly for a machine. The air cleaner assembly may include a filter housing and a filter element. The filter housing may include a mating surface extending in a first plane and defining a filter opening thereon. The filter housing also includes a filter engaging member associated with the mating surface. The filter element may include a filter frame extending generally in a second plane and defining an opening for receiving a filter medium. The filter element may also include a sealing member disposed in the filter frame around the opening and configured to seal around the opening when the filter frame is brought into contact with the mating surface. The filter element may further include a blade extending from the filter frame and configured to engage with the filter engaging member. In some exemplary embodiments, the filter engaging member and the blade may be configured such that, when the blade is engaged with the filter engaging member, the filter frame is rotatable about a tip of the blade.

### TECHNICAL FIELD

The present disclosure relates generally to an air ventilation system for the operator cabin of a machine and, more particularly, to an air cleaner assembly that can provide a consistent compression seal between a filter housing and a filter element.

### BACKGROUND

Off-highway trucks and work machines, such as, for example, tractors, wheel loaders, backhoe loaders, bulldozers, and excavators, may operate in and be exposed to harsh working environments with high concentrations of dust and debris. To provide a clean and comfortable atmosphere for the operator, off-highway trucks and work machines are generally equipped with enclosed operator cabins (often referred to as operator cabs) that can reduce the operator exposure to dust and debris, as well as noise and other hazardous conditions. Since the operator cabin is substantially enclosed, an off-highway truck or work machine typically includes a suitable ventilation and air-handling system (e.g., a HVAC system) to control the atmosphere inside the operator cabin by drawing fresh air from outside the cabin, heating or cooling the air as desired, and recirculating the air inside the cabin. The air in such a system is cleaned of dust and other debris by way of an air filter element disposed within the system.

To ensure continued supply of clean air to the operator cabin, a proper seal between a filter element and a filter housing is highly desirable, so that substantially all of the air flowing into the operator cabin can pass through the filter element. However, due to the limited space available for installation and/or removal of the filter element, the structural integrity of the seal can be often compromised. For example, during installation of a new filter element, a portion of the seal around the filter element may be damaged (e.g., torn or rolled) when the filter element is slid into a tight service opening and inadvertently brought into contact with a rough surface of the filter housing. Further, because the filter element is often held in place via a single point fastener (e.g., a wing nut, small latch, or bolt), around which the structural load of the filter element may be concentrated, the seal material disposed between a frame of the filter element and a filter housing may be subjected to an uneven compression force and may be deformed or torn, resulting in a lack of adequate seal compression between the filter element and the filter housing. If a consistent compression of the seal is not established at installation of the filter element and/or maintained for the usable life of the filter element, dirty air can bypass the filter element and leak into the operator cabin, creating an uncomfortable, unsanitary working environment inside the operator cabin.

One example of an air cleaner assembly for a vehicle is disclosed in U.S. Pat. No. 8,394,158 B2 (“the '158 patent”) to Shimomura et al. The air cleaner assembly disclosed in the '158 patent includes a case for housing a filter element and a cover that opens and closes an opening of the case for accessing the filter element. The assembly includes a hinge structure having a hinge formed to the cover and a hinge receiver formed to the case. The hinge structure allows the cover to pivot around the hinge with respect to the case.

Many problems and/or disadvantages still exist with the known air cleaner assemblies and filter elements. Various embodiments of the present disclosure may solve one or more of the problems and/or disadvantages discussed above.

### SUMMARY

According to one exemplary aspect, the present disclosure is directed to a filter element. The filter element may comprise a filter frame extending generally in a plane and defining an opening for receiving a filter medium. The filter element may also include a sealing member disposed in the filter frame around the opening and a blade extending from a first side of the filter frame at an angle relative to the plane of the filter frame. The blade may be configured to engage a portion of a filter housing.

Another exemplary aspect of the present disclosure may provide an air cleaner assembly comprising a filter housing and a filter element. The filter housing may include a mating surface extending in a first plane and defining a filter opening thereon. The filter housing also includes a filter engaging member associated with the mating surface. The filter element may include a filter frame extending generally in a second plane and defining an opening for receiving a filter medium. The filter element may also include a sealing member disposed in the filter frame around the opening and configured to seal around the opening when the filter frame is brought into contact with the mating surface. The filter element may further include a blade extending from the filter frame and configured to engage with the filter engaging member. In some exemplary embodiments, the filter engaging member and the blade may be configured such that, when the blade is engaged with the filter engaging member, the filter frame is rotatable about a tip of the blade.

In still another exemplary aspect, the present disclosure is directed to an air cleaner assembly having a filter housing configured to hold a first filter element and a second filter element. The filter housing may comprise a first filter engaging member configured to rotatably engage a first portion of a first filter element, a first latching member configured to latch a second portion of the first filter element, a second filter engaging member configured to rotatably engage a first portion of a second filter element, and a second latching member configured to latch a second portion of the second filter element. The first latching member and the second latching member have configurations different from one another with the configuration of the first latching member corresponding to the second portion of the first filter element and the configuration of the second latching member corresponding to the second portion of the second filter element, so to prevent incorrect filter elements from being installed to the filter housing.

### BRIEF DESCRIPTION OF THE DRAWINGS

FIG. 1 is a perspective view of a portion of an air cleaner assembly, illustrating a pair of filter elements installed onto a filter housing of the air cleaner assembly, according to one exemplary embodiment of the present disclosure;

FIG. 2 is a perspective view of the filter element shown in FIG. 1, according to one exemplary embodiment;

FIG. 3 is a perspective view of the air cleaner assembly of FIG. 1, illustrating an exemplary engagement between the filter element and the filter housing;

FIG. 4 is a top view of the filter element installed onto the filter housing;

FIGS. 5 and 6 are partial cross-sectional views of the filter element and the filter housing, illustrating their relative positions between a first position (FIG. 5), in which the filter element is aligned in a direction non-parallel to a mating surface of the filter housing, and a second position (FIG. 6), in which the filter element is aligned in a direction substantially parallel to the mating surface;

FIG. 7 is a cross-sectional view of a filter engaging member configured to rotatably engage with the filter element;

FIG. 8 is a frontal perspective view of a cover block for securing a pair of filter elements to a filter housing, according to one exemplary embodiment of the present disclosure;

FIG. 9 is a rear perspective view of the cover block of FIG. 8;

FIG. 10 is a perspective view of a cover block according to another exemplary embodiment; and

FIG. 11 is a perspective view of an air cleaner assembly employing a single filter element, according to another exemplary embodiment of the present disclosure.

### DETAILED DESCRIPTION

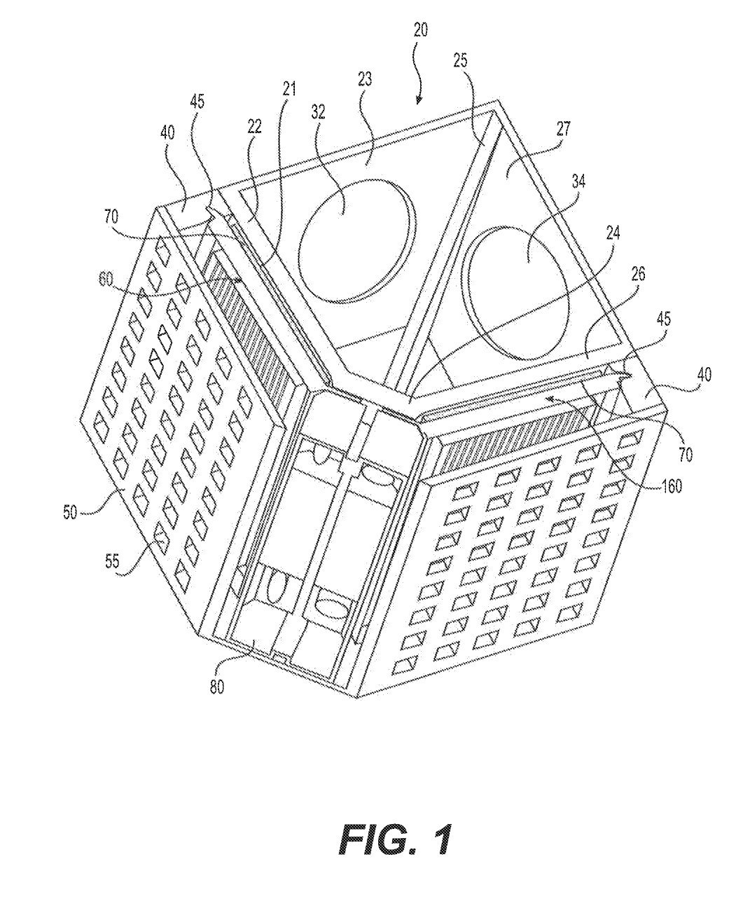

FIG. 1 illustrates a portion of an air cleaner assembly that can be used for the operator cabin of a vehicle, according to one exemplary embodiment of the present disclosure. While various embodiments of the present disclosure will be described in connection with a particular air cleaner assembly for an off-highway truck or work machine, it should be understood that the present disclosure may be applied to, or used in connection with, virtually any type of a machine that employs an air filtration system.

Referring to FIG. 1, the air cleaner assembly of the present disclosure may include a filter housing 20 and a pair of filter elements 60, 160 removably secured to filter housing 20. It should be noted that, unless specifically noted otherwise, filter element 60 and filter element 160, and certain related features in filter housing 20, are substantially identical to one another and, therefore, the features that are common to both filter element 60 and filter element 160 will be described with reference to filter element 60 only and any duplicative description relating to filter element 160 will be omitted.

Filter housing 20 may constitute a part of a flow conduit that provides cleaned air to the operator cabin (not shown). For example, filter housing 20 may include a first flow channel 23 and a second flow channel 27 separated from each other by a flow divider 25. First flow channel 23 and second flow channel 27 may be in flow communications with a first flow opening 32 and a second flow opening 34, respectively, where both of first flow opening 32 and second flow opening 34 may be, either directly or indirectly, connected to the operator cabin. First flow channel 23 may provide a passageway for air taken from outside the operator cabin to the operator cabin after the air is passed through filter element 60, and second flow channel 27 may provide a passageway for air recirculated from inside the operator cabin after the air is passed through filter element 160. In some alternative embodiments, filter housing 20 may not include flow divider 25, and first and second flow channels 23 and 27 may be combined with only one of first and second flow opening 32 and 34 connected to the operator cabin.

Filter housing 20 may include a first wall 22 defining a first filter opening 31 to be covered by filter element 60 and a second 26 defining a second filter opening 33 to be covered by filter element 160. First wall 22 and second wall 26 may be aligned substantially perpendicular to each other and may be joined together by a connecting wall 24, which may extend at an angle of approximately 45 degrees relative to each of first wall 22 and second wall 26. First and second filter openings 31 and 33 may be substantially rectangular, but may have any other shape depending on, for example, the shape of filter elements 60 and 160 intended to be used. The peripheral edges of each of first and second walls 22 and 26 may define a mating surface 21 for mating with a sealing member 70 of filter element 60 or 160.

According to some exemplary embodiments, as shown in FIG. 1, filter housing 20 may include a pair of cover plates 50 having a plurality of openings 55 for protecting filter elements 60 and 160 from potential damage from outside. Cover plates 50 may be integrally formed with first and second walls 22 and 26 to define filter spaces therebetween for receiving respective filter elements 60 and 160. In an alternative embodiment, cover plates 50 may be removably attached to first and second walls 22 and 26, in which case filter elements 60 and 160 may be installed and/or removed after removing cover plates 50 from filter housing 20.

Filter housing 20 may also include a filter engaging member 40 extending between first wall 22 and cover plate 50 for engaging a portion of filter element 60. As shown in FIG. 1, filter engaging member 40 may close one end of the space between first wall 22 and cover plate 50 and, if cover plate 50 is integrally formed with first wall 22, a service opening may be provided between cover plate 50 and first wall 22 adjacent connecting wall 24 for installation and/or removal of filter element 60. In various exemplary embodiments, filter engaging member 40 may be integrally formed with first wall 22 and/or cover plate 50. In an alternative embodiment, filter engaging member 40 may be removably arranged between first wall 22 and cover plate 50.

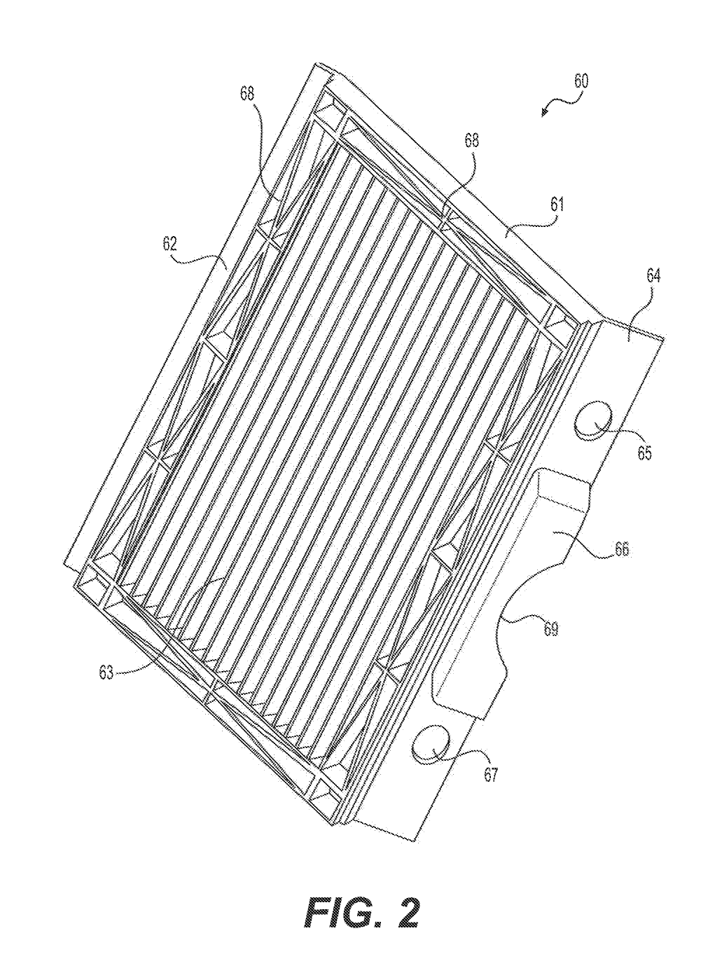

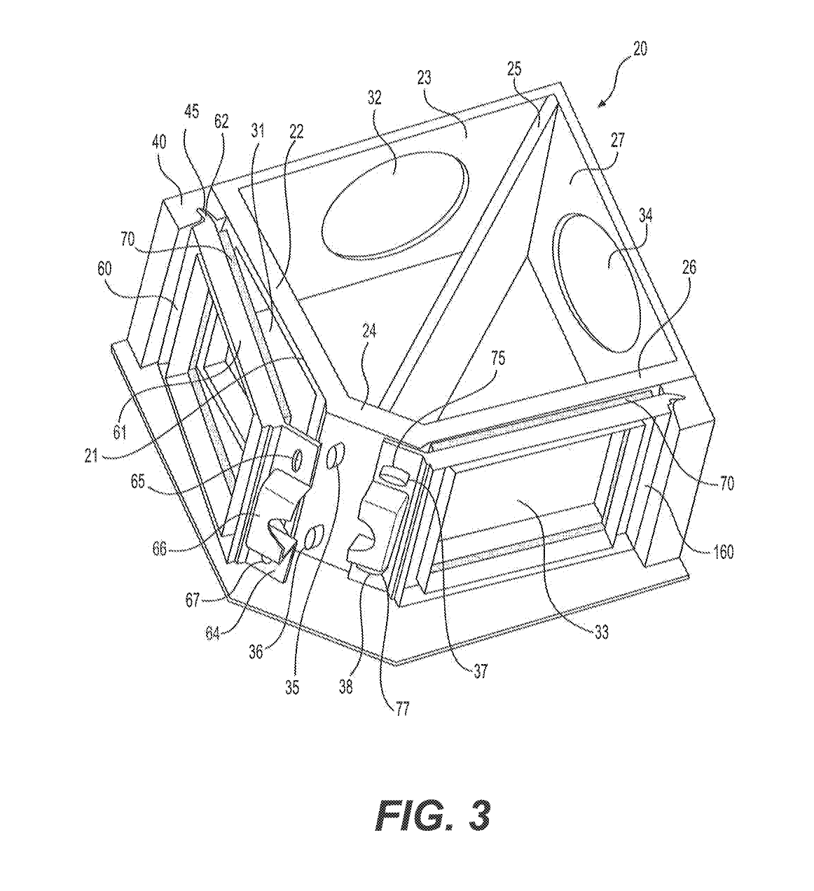

As will be described in more detail later with reference to FIGS. 3-7, filter engaging member 40 may define a groove 45 extending axially along a direction substantially perpendicular to mating surface 21 of first wall 22 to rotatably receive a blade 62 of filter element 60 (see FIG. 2), permitting filter element 60 to be inserted at an angle between cover plate 50 and first wall 22. The ability to insert and/or remove filter element 60 at an angle may eliminate the need for sliding filter element 60 in the direction parallel to mating surface 21 of first wall 22, thereby substantially reducing the risk of damaging sealing member 70 of filter element 60. Moreover, groove 45 may provide a stop feature for limiting the rotation of filter element 60 to a predetermined position that establishes a uniform spacing for sealing member 70 between filter frame 61 of filter element 60 and mating surface 21 of filter housing 20. Accordingly, a consistent seal compression can be maintained between filter element 60 and filter housing 20 by sealing member 70.

FIG. 2 illustrates filter element 60, according to one exemplary embodiment of the present disclosure. Filter element 60 may include a filter frame 61 having a substantially rectangular shape with an opening for receiving a suitable filter medium 63, such as, for example, fiberglass, polyester, metallic mesh, foam, and pleated paper. Filter frame 61 may be made of a metallic or plastic material. In some exemplary embodiments, filter frame 61 may include suitable structural reinforcements 68, such as, for example, cross bracings shown in FIG. 2. As mentioned above, filter element 60 may also include sealing member 70 attached to a surface of filter frame 61 facing mating surface 21 of first wall 22.

According to one exemplary aspect of the present disclosure, filter element 60 may include blade 62 extending from a first side surface of filter frame 61 for rotatably engaging with groove 45 of filter engaging member 40. As briefly mentioned above, blade 62 may extend from the side surface of filter frame 61 at an angle relative to the plane of filter frame 61, such that filter element 60 may be inserted in the space between cover plate 50 and first wall 22 at an angle with respect to cover plate 50 and first wall 22.

In the exemplary embodiment shown in FIG. 2, blade 62 may extend along substantially the entire length of the first side surface. Groove 45 that receives blade 62 may have the same length as the length of blade 62 and may be positioned at a predetermined axial elevation in filter engaging member 40 to pre-set the correct height of filter element 60 relative to filter housing 20 for effective seal compression.

According to another exemplary aspect of the present disclosure, filter element 60 may also include a latching plate 64 extending from a second side surface of filter frame 61, which is opposite to the first side surface. Latching plate 64 may extend from the second side surface at an angle, so that its surface facing connecting wall 24 can be substantially flush with an outer surface of connecting wall 24, as shown in FIG. 1. Latching plate 64 may include a first latching hole 65 and a second latching hole 67 configured to receive a first pin 35 and a second pin 36, respectively, which extend from connecting wall 24 of filter housing 20 (see FIG. 3).

In some exemplary embodiments, first and second latching holes 65 and 67 of filter element 60 may be slightly offset to create an interference fit therebetween. The offset may also cause blade 62 of filter element 60 on the opposite side to be pushed into groove 45. The interference fit may function to temporarily hold filter element 60 onto filter housing 20 until a cover block is installed to finally secure filter element 60 in place.

Latching plate 64 may also include a suitable handle 66 to facilitate removal of filter element 60 from filter housing 20. For example, as shown in FIG. 2, latching plate 64 may include a raised portion with a recess 69 to permit a serviceman to insert one or more fingers thereto to grip and lift latching plate 64 away from connecting wall 24 to disengage first and second latching holes 65 and 67 from first and second pins 35 and 36.

With reference to FIGS. 3-7, the exemplary engagement between filter element 60 and filter housing 20 is described in more detail. FIG. 3 depicts the same embodiment as shown in FIG. 1, except that filter housing 20 is shown without cover plates 50 and that filter elements 60 and 160 are shown without filter medium 65 to facilitate the visualization and understanding of relevant features inside filter housing 20.

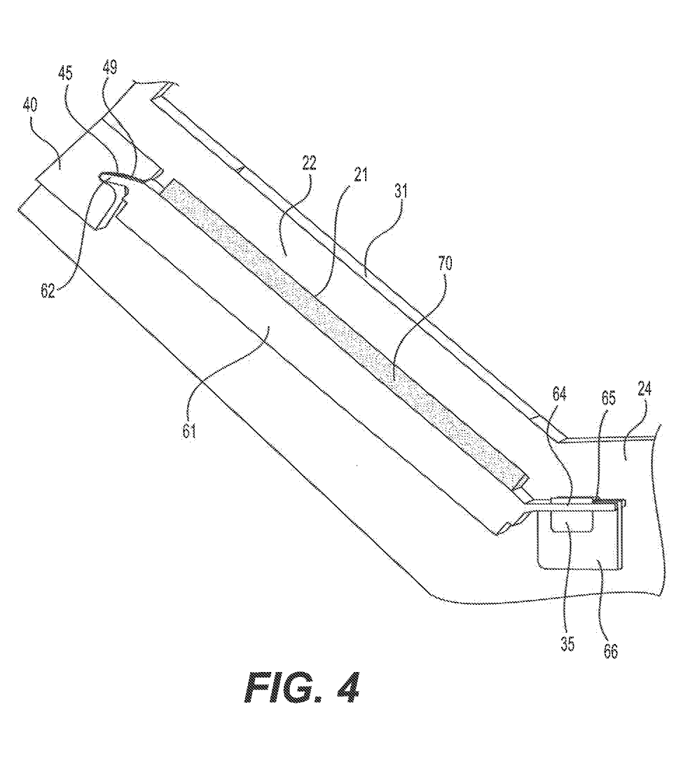

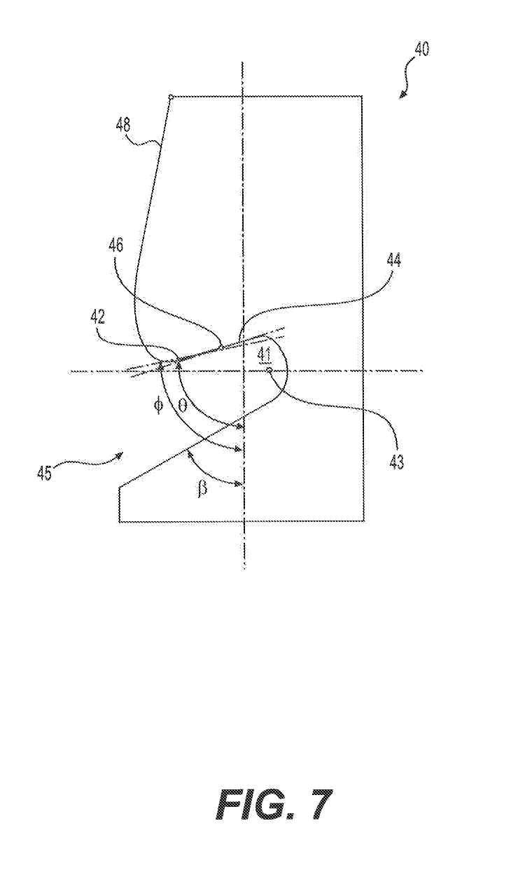

As mentioned above, groove 45 may have a shape and configuration to rotatably receive blade 62 of filter element 60. For example, as best shown in FIGS. 4 and 7, groove 45 may have a cross-section that opens out in a direction generally parallel to mating surface 21 of first wall 22. The shape and configuration of groove 45 may allow filter element 60 to engage and/or disengage groove 45 at an angle without the need for sliding filter element 60 in contact with a portion of filter housing 20 during installation and/or servicing, thereby substantially preventing potential damage to sealing member 70 of filter element 60.

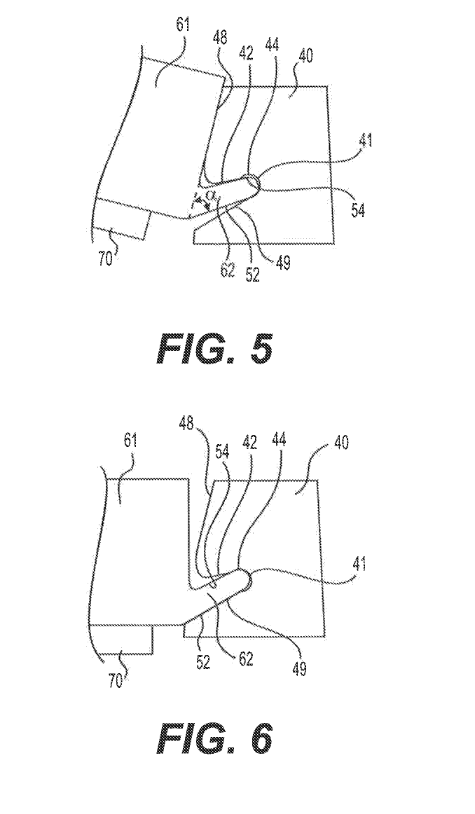

For example, as best shown in FIG. 7, groove 45 may include a receiving end 41 configured to rotatably receive a tip portion of blade 62. In some exemplary embodiments, receiving end 41 may have a substantially semi-circular cross-section, such that the tip of blade 62 having a rounded cross-section may be rotatably received therein and blade 62 may pivot about a pivot point 43. Groove 45 may also include two side surfaces 47 and 49, extending from receiving end 41 towards the open end of groove 45. First side surface 49 may have an angle β that substantially matches with an extension angle α of blade 62 (see FIG. 5). By way of example only, angle β may be approximately 65 degrees when measured from a longitudinal axis, as shown in FIG. 7.

Angled first side surface 49 may function as a stop member for limiting the rotation of filter element 60 from a first position (FIG. 5), in which the plane of filter frame 61 is non-parallel with respect to mating surface 21 of first wall 22, to a second position (FIG. 6), in which the plane of filter frame 61 is aligned substantially parallel with respect to mating surface 21. For example, when filter element 60 is rotated to the second position shown in FIG. 6, first side surface 49 may contact a front surface 52 of blade 62, preventing further rotation of filter element 60 with respect to filter engaging member 40.

Providing angled first side surface 49 as a stop member in groove 45 may ensure a constant and uniform spacing between filter frame 61 of filter element 60 and mating surface 21 of first wall 22, thereby allowing a consistent seal compression to be established and maintained between filter housing 20 and filter element 60. Such a stop member may further ensure that the space created for sealing member 70 is not affected by over-tightening of a fastener for filter element 60 or, in the case of horizontal applications, the weight of filter element 60, which can press down on sealing member 70. As shown in FIG. 4, when filter element 60 is secured onto filter housing 20, sealing member 70 may have a consistent compression throughout filter element 60.

Alternatively or additionally, one or more stop members may be provided between latching plate 64 and filter housing 20 to pre-set an optimal height of sealing member 70. For example, latching plate 64 may include one or more protrusions (not shown) extending from latching plate 64 toward connecting wall 24 to create a predetermined spacing that corresponds to a desired height for sealing member 70 of filter element 60. In an alternative embodiment, the one or more protrusions may be extended from connecting wall 24 towards latching plate 64 to create the same predetermined spacing.

Referring to FIG. 7, second side surface 47 of groove 45 for contacting a back surface 54 of blade 62 may be configured such that a sufficient spacing is provided in groove 45 for the rotation of blade 62 between the first position (FIG. 5) and the second position (FIG. 6). Accordingly, second side surface 47 may include a first contact surface 42 and a second contact surface 44, which are joined with one another at an interface point 46. First and second contact surfaces 42 and 44 may be non-parallel to one another and have different extension angles φ and θ to accommodate the rotational movement of blade 62 inside groove 45. For example, second contact surface 44 may extend at angle θ, and first contact surface 42 may extend at angle φ that is greater than angle θ of second contact surface 44. The difference between angle φ and angle β (i.e., φ−β) may ultimately represent the amount of rotation permitted between filter element 60 and filter housing 20.

By way of examples only, in some exemplary embodiments, angle θ may range from approximately 65 degrees to approximately 75 degrees, and angle φ may be approximately 80 degrees. It should be understood that angles α, β, θ, and φ may vary significantly based on a number of factors, including, but not limited to, the type of filter used, the desired amount of rotation for filter element 60, and the size of the service opening in filter housing 20 for installation and/or removal of filter element 60.

When blade 62 of filter element 60 is inserted into groove 45 of filter engaging member 40 in the first position, as shown in FIG. 5, first contact surface 42 of groove 45 may contact with back surface 54 of blade 62. At this position, second contact surface 44 may not contact any portion of back surface 54 of blade 62, while the tip of blade 62 is received in receiving end 41 of groove 42. A side contacting surface 48 of filter engaging member 40 may be configured to mate with the side surface of filter frame 61 at this first position. Further, filter engaging member 40 may form a smooth, rounded transition portion between side contacting surface 48 and second side surface 47, so that the transition portion may not interfere with the rotational movement of filter element 60. When blade 62 of filter element 60 is rotated about pivot point 43 to the second position shown in FIG. 6, front surface 52 of blade may contact first side surface 49 of groove 45 to limit the rotational movement of filter element 60, while second contact surface 44 of groove 45 may contact with back surface 54 of blade 62 to hold the tip of blade 62 in groove 45. At this second position, first contact surface 42 may not contact any portion of back surface 54 of blade 62.

According to another exemplary aspect of the present disclosure, filter housing 20 and filter elements 60 and 160 may include a mistake-proofing mechanism (e.g., a poky-yoke feature) to prevent incorrect filter elements from being installed. For example, as shown in FIG. 3, first and second pins 35 and 36 and first and second latching holes 65 and 67, which are used to secure filter element 60 to filter housing 20 for first flow channel 23, may have different configurations than third and fourth pins 37 and 38 and third and fourth latching holes 75 and 77, used for securing filter element 160 to filter housing 20 for second flow channel 27, so that only the predetermined types of filter elements can be installed to the respective filter housing 20. The different configurations may include different geometric features, such as different shapes and/or sizes, in the disclosed exemplary embodiment, first and second pins 35 and 36 and first and second latching holes 65 and 67 have an oval shape aligned vertically, while third and fourth pins 37 and 38 and third and fourth latching holes 75 and 77 have the same oval shape but aligned horizontally. Such a mistake-proofing mechanism may ensure installation of the correct filter element to filter housing 20, especially when the air cleaner assembly employs two or more filter elements of different types.

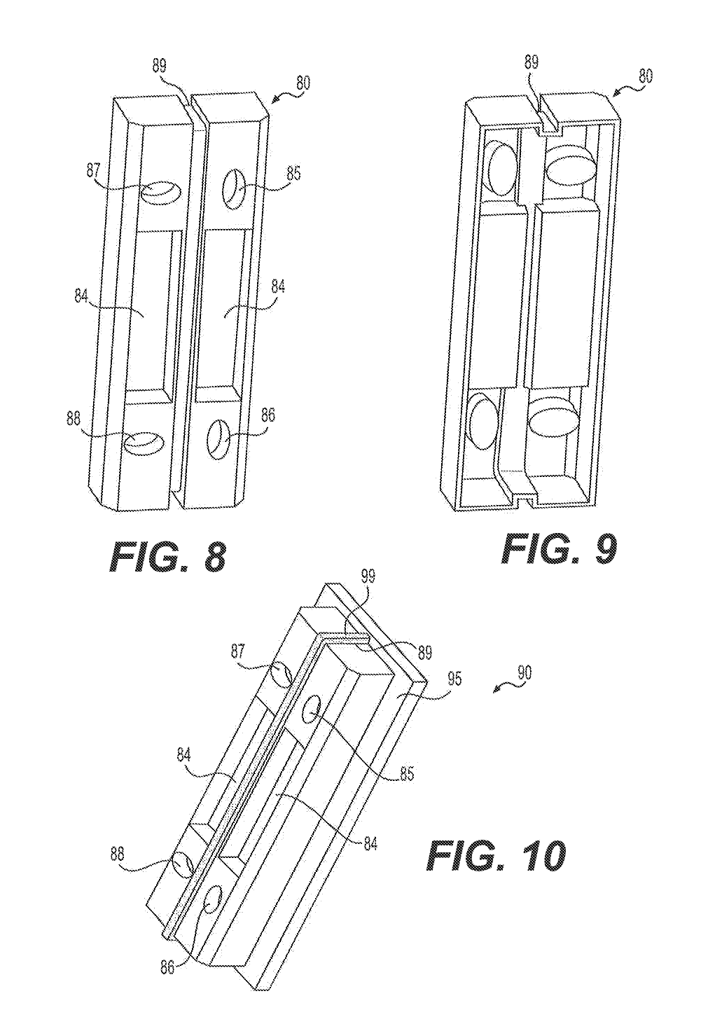

FIGS. 8 and 9 illustrate a cover block 80 for securing filter elements 60 and 160 to filter housing 20, according to one exemplary embodiment. Cover block 80 may include first locking hole 85 and second locking hole 86 that are configured to mate with first pin 35 and second pin 36, respectively, which are protruding past first latching hole 65 and second latching hole 67, respectively, of filter element 60 for engaging with cover block 80. Cover block 80 may also include third locking hole 87 and fourth locking hole 88 that are configured to mate with third pin 37 and fourth pin 38, respectively, which are protruding past third latching hole 75 and fourth latching hole 77, respectively, of filter element 160. Cover block 80 may also include handle recesses 84 for accommodating handles 66 of filter elements 60 and 160. When first, second, third, and fourth locking holes 85, 86, 87, and 88 mate with first, second, third, and fourth pins 35, 36, 37, and 38, respectively, cover block 80 may prevent filter elements 60 and 160 from rotating because any lateral movement of filter elements 60 and 160 is substantially restricted by cover block 80.

Cover block 80 may also include a sealing groove 89 extending from the top surface to the bottom surface in the area between first and second locking holes 85 and 86 and third and fourth locking holes 87 and 88. Sealing groove 89 may be configured to receive a suitable sealing member 99 (see FIG. 10) to seal between filter elements 60 and 160. Sealing member 99 provided in sealing groove 89 may prevent the two air streams associated with first and second flow channels 23 and 27 from mixing with each other before they enter their respective filter elements 60 and 160.

FIG. 10 illustrates a cover block 90, according to another exemplary embodiment. This embodiment differs from the embodiment shown in FIGS. 8 and 9 in that cover block 90 includes a back plate 95 covering the rear face of cover block 90.

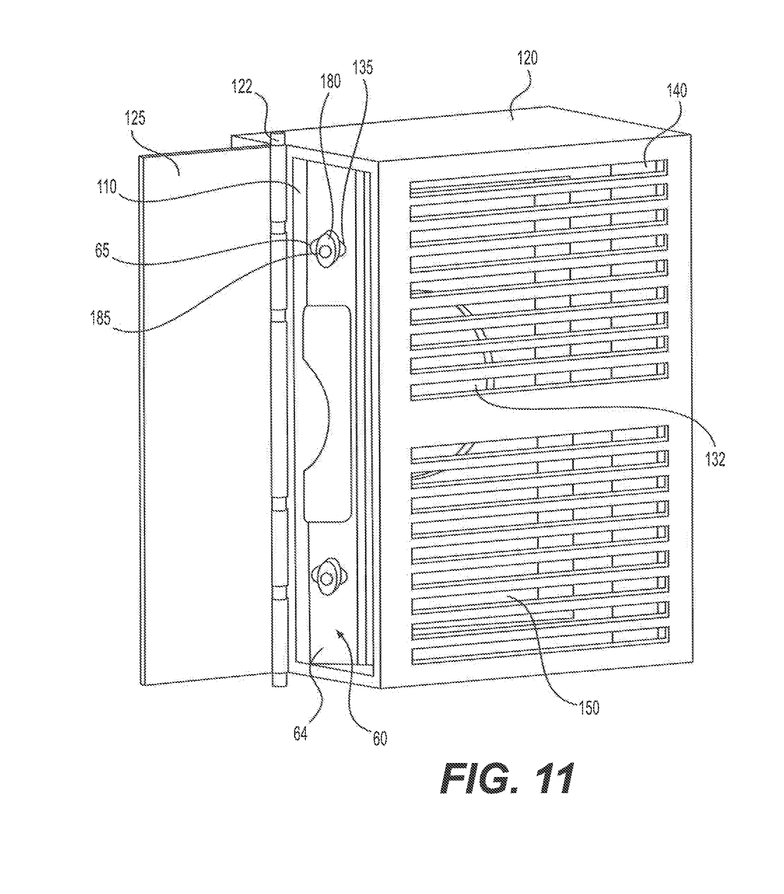

While the present disclosure was described above in connection with the air cleaner assembly employing a pair of filter elements 60 and 160, the present disclosure may be applied to any air cleaner assembly employing only a single filter element. For example, as shown in FIG. 11, an air cleaner assembly, according to another exemplary embodiment, may include a filter housing 120 and filter element 60 removably secured to filter housing 120. It should be noted that the air cleaner assembly of FIG. 11 illustrates filter element 60 without a filter medium to facilitate visualization of the disclosed embodiment.

Like filter housing 20 described above with reference to FIGS. 1, 3, and 4, filter housing 120 may constitute a part of a flow conduit that provides cleaned air to the operator cabin. For example, filter housing 120 may include one or more inlet openings 150 for receiving air taken from either inside (e.g., recirculated air) or outside (e.g., fresh air) the operator cabin, depending on the application. Filter housing 120 may also include an outlet opening 132 that is connected to an air passage to the operator cabin. Filter housing 120 may define an internal space between inlet openings 150 and outlet opening 132, which can be accessed through an access opening 110 formed on a side surface of filter housing 120. Access opening 110 can be opened and closed by an access door 125 pivotally coupled to filter housing 120 via a suitable hinge 122.

On a side opposite to access opening 110, filter housing 120 may include a filter engaging member 140 for rotatably receiving filter element 60. It should be noted that, unless otherwise specifically noted herein, features relating to filter element 60 and its engagement with filter housing 120, including filter engaging member 140, are substantially identical to the above-described embodiments and, therefore, any detailed description relating to those features will be omitted herein.

In some exemplary embodiments, the air cleaner assembly may include a suitable latching device configured to secure filter element 60 to filter housing 120. For example, according to the exemplary embodiment shown in FIG. 11, the latching device may include a protrusion 135 extending from a surface of filter housing 120 and a knob 180 rotatably coupled to protrusion 135 via a pivot pin 185 extending from protrusion 135. Protrusion 135 may have the same shape and size as latching hole 65 of filter element 60. Protrusion 135 may extend from the surface of filter housing 2.0 only a distance substantially equal to the thickness of latching plate 64 such that, when protrusion 135 is received in latching hole 65, the top surface of protrusion 135 may be substantially flush with the top surface of latching plate 64. Knob 180 may also have the same shape and size as protrusion 135 and latching hole 65, but may be rotatable between a first position, in which knob 180 and protrusion 135 are substantially aligned with respect to one another, and a second position, in which knob 180 and protrusion 135 are misaligned (e.g., oriented perpendicularly) with respect to one another. To install or remove filter element 60 from filter housing 120, knob 180 may be rotated to the first position, where knob 180 and protrusion 135 can be freely inserted into or removed from latching hole 65. Once filter element 60 is placed in filter housing 120 with knob 180 and protrusion 135 received in latching hole 65, knob 180 may be rotated to the second position to secure latching plate 64 to filter housing 120. At the position, the bottom surface of knob 180 may contact the top surface of latching plate 64, as shown in FIG. 11. The latching device described above is exemplary only, and any other latching device known in the art that would be suitable for securing latching plate 64 to filter housing 120 may be used alternatively or additionally.

### INDUSTRIAL APPLICABILITY

The disclosed air cleaner assembly may be applicable to various filter elements used in a machine, including various off-highway trucks and work machines, such as, for example, tractors, wheel loaders, backhoe loaders, bulldozers, and excavators. When applied to a motor vehicle, the air cleaner assembly according to the present disclosure may substantially reduce the risk of sealing failure between a filter element and a filter housing by establishing and maintaining a consistent seal compression therebetween during the useful life of the filter element. This may reduce the maintenance costs associated with time-consuming repair or replacement of failed sealing members and/or filter elements. With reference to FIGS. 1-6, an exemplary process of applying the air cleaner assembly of the present disclosure to a motor vehicle to establish and maintain a consistent seal compression between filter element 60 and filter housing 20 will be described herein.

To install filter element 60 to filter housing 20, filter element 60 may be inserted, via the service opening adjacent connecting wall 24, into the filter space between cover plate 50 and mating surface 21 of first wall 22. If cover plate 50 is removable, cover plate 50 can be removed before inserting filter element 60 through the service opening. Filter element 60 may be inserted further into the filter space to have its blade 62 engage with groove 45 of filter engaging member 40. As filter element 60 is being inserted, filter element 60 can be oriented at an angle relative to mating surface 21 of first wall 22, as shown in FIGS. 3 and 5, such that sealing member 70 may not contact with mating surface 21 of first wall 22. The ability to insert filter element 60 at an angle may eliminate or otherwise reduce the risk of damaging sealing member 70 caused by sliding filter element 60 against mating surface 21 of filter housing 20.

Once blade 62 of filter element 60 is received in groove 45 of filter engaging member 40, filter element 60 may be rotated about the tip of blade 62 towards mating surface 21 of first wall 22 with sealing member 70 sealingly disposed between filter frame 61 and mating surface 21. Due to angled first side surface 49 of groove 45 abutting against angled front surface 52 of blade 62 at a predetermined rotational angle, the rotation of filter element 60 may be limited to a predetermined position, where the plane of filter frame 61 becomes substantially parallel to mating surface 21 of first wall 22. Because filter frame 61 is substantially parallel to mating surface 21, a uniform spacing for sealing member 70 can be maintained therebetween, and sealing member 70 can establish and/or maintain a consistent seal compression. When filter element 60 is rotated to the predetermined rotational angle shown in FIGS. 4 and 6, first and second latching holes 65 and 67 of latching plate 64 may receive first and second pins 35 and 36, respectively, of connecting wall 24 to temporarily hold filter element 60 onto filter housing 20. Filter element 160 can be installed in substantially the same manner as filter element 160, and any detailed description thereof will be omitted herein. The mistake-proofing feature associated with latching plate 64 may ensure installation of the correct filter elements to filter housing 20.

After first and second pins 35 and 36 and third and fourth pins 37 and 38, each extending from connecting wall 24, are received in first and second latching holes 65 and 67 and third and fourth latching holes 75 and 77, respectively, cover block 80 may be used to secure filter elements 60 and 160 to filter housing 20. For example, cover block 80 may be placed over latching plates 64 with its first, second, third, and fourth locking holes 85, 86, 87, and 88 mating with first, second, third, and fourth pins 35, 36, 37, and 38, respectively.

It will be apparent to those skilled in the art that various modifications and variations can be made to the disclosed air cleaner assemblies. Other embodiments will be apparent to those skilled in the art from consideration of the specification and practice of the disclosed method and apparatus. It is intended that the specification and examples be considered as exemplary only, with a true scope being indicated by the following claims and their equivalents.

What is claimed is:

1. A filter element comprising:
a filter frame extending generally in a plane and defining an opening for receiving a filter medium;
a sealing member disposed in the filter frame around the opening; and
a blade extending from a first side of the filter frame at an angle relative to the plane of the filter frame, the blade being configured to engage a portion of a filter housing.

2. The filter element of claim 1, wherein the blade extends substantially an entire length of the first side of the filter frame.

3. The filter element of claim 1, wherein the filter frame is substantially rectangular.

4. The filter element of claim 1, further comprising a latching plate extending from a second side of the filter frame opposite to the first side, the latching plate being configured to engage another portion of the filter housing after the blade engages the portion of the filter housing.

5. The filter element of claim 4, wherein the latching plate extends from the second side of the filter frame at an angle relative to the plane of the filter frame.

6. The filter element of claim 4, wherein the latching plate comprises a latching hole for receiving a pin extending from the filter housing.

7. The filter element of claim 1, wherein, after the blade engages the portion of the filter housing, the filter frame is configured rotate about a tip of the blade to allow the sealing member to be disposed between the filter frame and a mating surface of the filter housing.

8. An air cleaner assembly comprising:
a filter housing comprising:
a mating surface extending in a first plane and defining a filter opening thereon; and
a filter engaging member associated with the mating surface; and
a filter element comprising:
a filter frame extending generally in a second plane and defining an opening for receiving a filter medium;
a sealing member disposed in the filter frame around the opening and configured to seal around the opening when the filter frame is brought into contact with the mating surface; and
a blade extending from the filter frame and configured to engage with the filter engaging member,
wherein the filter engaging member and the blade are configured such that, when the blade is engaged with the filter engaging member, the filter frame is rotatable about a tip of the blade.

9. The air cleaner assembly of claim 8, wherein the filter frame is rotatable between a first position in which the first plane is non-parallel with respect to the second plane and a second position in which the first plane is substantially parallel with respect to the second plane.

10. The air cleaner assembly of claim 9, wherein the filter engaging member comprises a stop member for limiting the rotation of the filter frame from the first position to the second position.

11. The air cleaner assembly of claim 8, wherein the blade extends from a first side of the filter frame at an angle relative to the second plane.

12. The air cleaner assembly of claim 8, wherein the filter engaging member comprises a groove, and the blade rotatably engages with the groove.

13. The air cleaner assembly of claim 12, wherein the groove comprises an angled surface substantially conforming to a surface of the blade, such that the rotation of the filter frame limited to a position in which the first plane is substantially parallel with respect to the second plane.

14. The air cleaner assembly of claim 12, wherein the groove extends in a length substantially the same as a length of the blade.

15. The air cleaner assembly of claim 8, wherein the blade extends substantially an entire length of the first side.

16. The air cleaner assembly of claim 8, wherein the blade extends from a first side of the filter frame, and wherein the filter element further comprises a latching plate extending from a second side of the filter frame, opposite to the first side, the latching plate being configured to engage with the filter housing after the blade engages with the filter engaging member.

17. The air cleaner assembly of claim 16, wherein the latching plate extends from the second side of the filter frame at an angle relative to the second plane and in a direction away from the blade with respect to the second plane.

18. The air cleaner assembly of claim 17, wherein the latching plate comprises a latching hole for receiving a pin extending from the filter housing.

19. An air cleaner assembly comprising:
a filter housing configured to hold a first filter element and a second filter element, the. filter housing comprising:
a first filter engaging member configured to rotatably engage a first portion of a first filter element;
a first latching member configured to latch a second portion of the first filter element;
a second filter engaging member configured rotatably engage a first portion of a second filter element; and
a second latching member configured to latch a second portion of the second filter element,
wherein the first latching member and the second latching member have configurations different from one another with the configuration of the first latching member corresponding to the second portion of the first filter element and the configuration of the second latching member corresponding to the second portion of the second filter element, so as to prevent incorrect filter elements from being installed to the filter housing.

20. The air cleaner assembly of claim 19, wherein the different configurations comprise at least one of shape and size.
